(19) United States
(12) Patent Application Publication
(10) Pub. No.: US 2022/0284147 A1
(43) Pub. Date: Sep. 8, 2022

(54) DRAWING DATA PROCESSING APPARATUS AND DRAWING DATA PROCESSING METHOD

(71) Applicant: KABUSHIKI KAISHA TOSHIBA, Tokyo (JP)

(72) Inventors: Mieko ASANO, Kawasaki Kanagawa (JP); Reiko NODA, Kawasaki Kanagawa (JP); Yojiro TONOUCHI, Inagi Tokyo (JP)

(73) Assignee: KABUSHIKI KAISHA TOSHIBA, Tokyo (JP)

(21) Appl. No.: 17/458,732

(22) Filed: Aug. 27, 2021

(30) Foreign Application Priority Data
Mar. 4, 2021 (JP) 2021-034171

(51) Int. Cl. G06F 30/13; G06F 30/12; G06T 7/50

(52) U.S. Cl. CPC G06F 30/13; G06F 30/12; G06T 7/50; G06F 2111/20

(57) ABSTRACT

According to one embodiment, a drawing data processing apparatus includes processing circuitry. The processing circuitry is configured to acquire a plurality of object data items relating to a plurality of objects, the objects composing a drawing, acquire attribute information relating to the objects from the object data items, filter the object data items based on the acquired attribute information, a dictionary including a plurality of filtering conditions associated with a plurality of data utilization purposes, and an input data utilization purpose to generate a filtering result, and output the filtering result.

### CROSS-REFERENCE TO RELATED APPLICATIONS

This application is based upon and claims the benefit of priority from Japanese Patent Application No. 2021-034171, filed Mar. 4, 2021, the entire contents of which are incorporated herein by reference.

### FIELD

Embodiments described herein relate generally to a drawing data processing apparatus and a drawing data, processing method.

### BACKGROUND

When creating drawing data such as computer-aided design (CAD) data, a user creates a drawing with a purpose; therefore, each object composing the drawing is provided with, for example, a line width, a line color, a line type, and a layer name. Information of drawing data is often managed in layers for better visibility. However, when a user intends to utilize drawing data created by another user, the other user's layer classification and attribute assignment are often insufficient.

When a user utilizes drawing data for a purpose different from the purpose for which another user created the drawing data, the drawing data may include unnecessary object data. Therefore, a user needs to manually sort out necessary object data and unnecessary object data, which causes low work efficiency.

### BRIEF DESCRIPTION OF THE DRAWINGS

FIG. 1 is a block diagram showing a drawing data processing apparatus according to an embodiment.

FIG. 2 is a diagram illustrating a usage example of the drawing data processing apparatus shown in FIG. 1.

FIG. 3 is a flowchart showing an example of filtering executed by a filtering unit shown in FIG. 1.

FIG. 4 is a flowchart showing another example of filtering executed by the filtering unit shown in FIG. 1.

FIG. 5 is a block diagram showing a hardware configuration example of a computer according to the embodiment.

### DETAILED DESCRIPTION

According to one embodiment, a drawing data processing apparatus includes processing circuitry. The processing circuitry is configured to acquire a plurality of object data items relating to a plurality of objects, the objects composing a drawing, acquire attribute information relating to the objects from the object data items, filter the object data items based on the acquired attribute information, a dictionary including a plurality of filtering conditions associated with a plurality of data utilization purposes, and an input data utilization purpose to generate a filtering result, and output the filtering result.

Hereinafter, embodiments will be described with reference to the accompanying drawings.

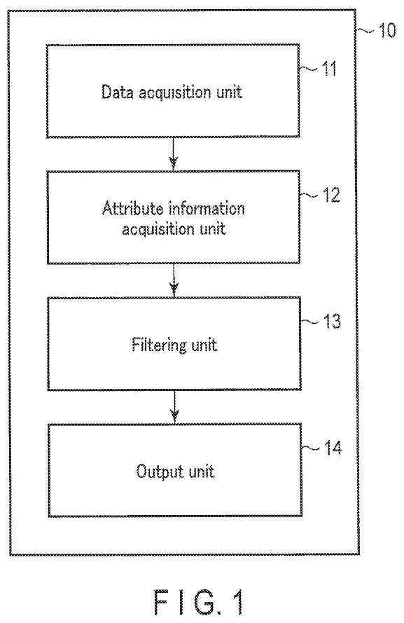

FIG. 1 schematically shows a drawing data processing apparatus 10 according to one embodiment. As shown in FIG. 1, the drawing data processing apparatus 10 includes a data acquisition unit 11, an attribute information acquisition unit 12, a filtering unit 13, and an output unit 14.

The data acquisition unit 11 acquires drawing data including a plurality of object data items respectively relating to a plurality of objects composing a drawing. Each object data item expresses object information, which is information relating to a corresponding one of the objects, by a numerical value or a character string. The object information may include information indicating, for example, a shape, a layer name, a position (coordinate values), a line width, a line color, and a line type. Drawing data in which objects are classified into layers may include display state information indicating the display state (display/non-display) of each layer. The display state may be set by a user who creates drawing data.

Drawing data acquired by the data acquisition unit 11 may be vector data, such as data in SVG format or DXF format, which is an intermediate file format of AutoCAD. In chis case, each object data item is data describing characteristics of an object in vector format. When image data (raster data) is input, to the drawing data processing apparatus 10, the data acquisition unit 11 may acquire drawing data by receiving the image data and performing raster-to-vector conversion on the image data. Drawing data may be in any format that can handle figures and character strings as objects.

The attribute information acquisition unit 12 acquires attribute information relating to a plurality of objects from a plurality of object data items included in the drawing data acquired by the data acquisition unit 11. Attribute information is information indicating an attribute of each object, and includes information indicating, for example, a shape, layer name, position, line width, line color, and line type of each object. When there is a connection relationship between objects (such as line segments or figures), the attribute information acquisition unit 12 may further acquire connection information indicating a connection relationship between objects as attribute information. When an object data item includes information specific to the object, such as time when the object is generated or edited, the attribute information acquisition unit 12 may further acquire the information specific to the object as attribute information. Namely, the attribute information acquisition unit 12 may acquire all types of information that can be acquired for each object as attribute information of the object. The attribute information may further include information indicating the display state of each layer.

The filtering unit 13 filters object data items included in the drawing data acquired by the data acquisition unit 11 based on the attribute information acquired by the attribute information acquisition unit 12, a dictionary including a plurality of filtering conditions respectively associated with a plurality of data utilization purposes, and an input data utilization purpose to generate a filtering result. The input data utilization purpose is a data utilization purpose input by a user who intends to utilize drawing data. The data utilization purpose represents a purpose of utilizing drawing data. In an example, each filtering condition may include information designating characteristics of objects necessary for a corresponding one of the data utilization purposes. Examples of the characteristics include a shape and a type. The dictionary may be configured to extract an object data item relating to an object having characteristics designated by each filtering condition. The filtering unit 13 uses the dictionary to extract an object data item relating to an object having characteristics designated by a filtering condition associated with a data utilization purpose that matches the input data utilization purpose. Characteristics of objects necessary for each data utilization purpose may be manually determined or determined by machine learning. The dictionary may be one created specifically for the drawing data processing apparatus 10, or may be one created for another purpose. The filtering condition is not limited to the above described examples. The filtering result includes, for example, one or more object data items matching the input data utilization purpose, which are extracted by the filtering unit 13.

The output unit 14 outputs a filtering result generated by the filtering unit 13. The output unit 14 may output the object data item extracted by the filtering unit 13 as an intermediate file in DXF format or SVG format. The output unit 14 may render the object data item extracted by the filtering unit 13 on a screen. The output unit 14 may convert the object data item extracted by the filtering unit 13 into image data and output the image data. The output unit 14 may add a new layer to the drawing data acquired by the data acquisition unit 11, and copy or move the object data item extracted by the filtering unit 13 to the added layer.

The drawing data processing apparatus 10 having the above-described configuration extracts object data items necessary for the user's data utilization purpose from a plurality of object data items. This eliminates the necessity for the user to sort out object data items. As a result, user's work efficiency greatly improves.

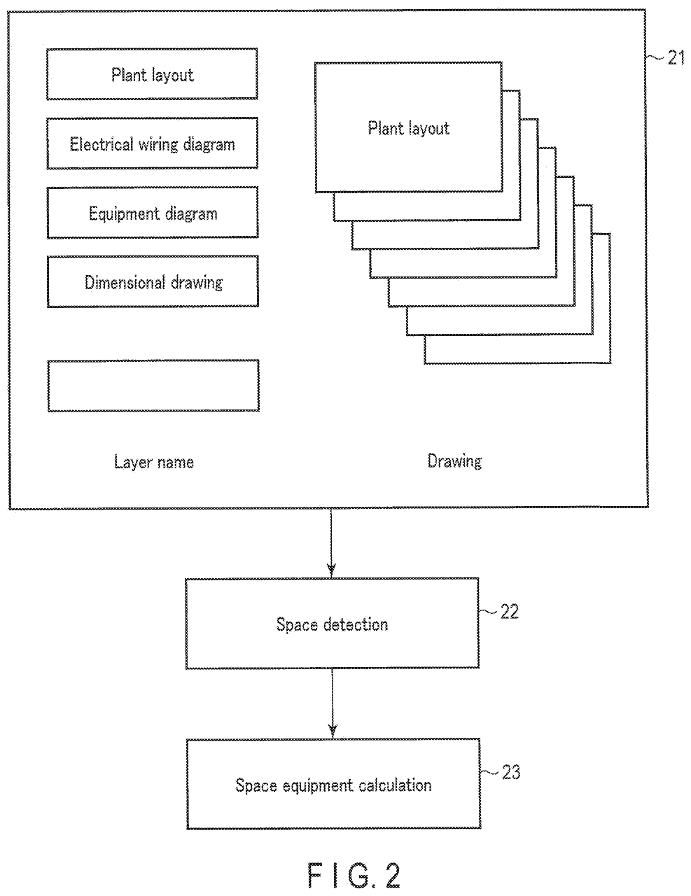

With reference to FIG. 2, the case where an installation area and size of a new air conditioner are calculated from a drawing of the inside of a plant, drawing data of which is managed in a plurality of layers, will be described.

As shown in FIG. 2, the data acquisition unit 11 acquires CAD data 21 as drawing data. The CAD data 21 is managed in a plurality of layers including a plant layout, an electrical wiring diagram, an equipment diagram, and a dimensional drawing. A plurality of objects may belong to each layer. The attribute information acquisition unit 12 acquires, from the CAD data 21, attribute information relating to the objects included in the drawing.

The CAD data 21 includes information on plant layout and wiring, but does not include space information indicating a space to install an air conditioner. A space to install an air conditioner is detected based on, for example, a window, a wall, a door, and an installation composing a room; however, the CAD data 21 does not include information indicating such attributes. To detect a room, an object data item relating to an object corresponding to an element of the room needs to be extracted from the CAD data 21.

The filtering unit 13 selects an object that is an element of the room from the objects included in the drawing, and extracts an object data item relating to the selected object. The output unit 14 outputs an object data item extracted by the filtering unit 13 to a data processing unit (not shown).

The data processing unit performs space detection 22 for detecting a space to install an air conditioner, based on the object data item extracted by the filtering unit 13. The data processing unit also performs space equipment calculation 23 for calculating specifications of an air conditioner in accordance with the size of the detected space.

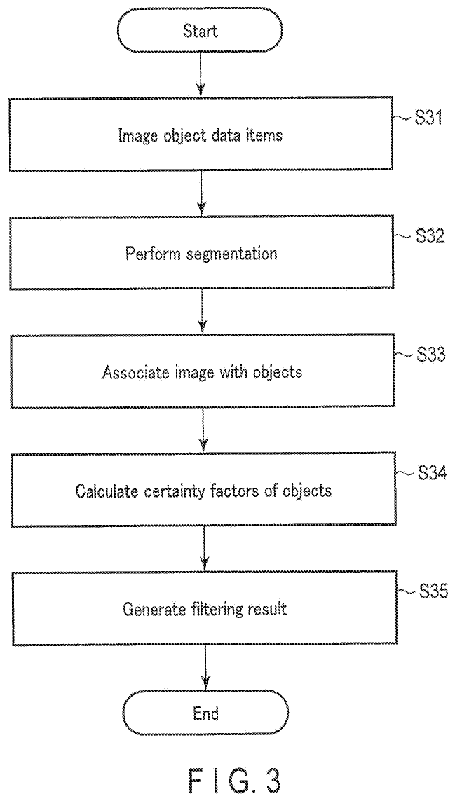

FIG. 3 schematically shows an example of filtering executed by the filtering unit 13. Here, the case where the input data utilization purpose is room (space) detection will be taken as an example.

First, the filtering unit 13 converts a plurality of object data items acquired by the data acquisition unit 11 into image data (step S31 in FIG. 3). The filtering unit 13 may generate image data by selecting at least one of the object data items based on the attribute information acquired by the attribute information acquisition unit 12 and performing vector-to-raster conversion on at least one selected object data item. For example, the filtering unit 13 may select at least one object data item based on at least one of the position of the object, the shape of the object, the color of the object, and the display state of the layer, which are specified by the attribute information acquired by the attribute information acquisition unit 12. For example, the filtering unit 13 selects an object data item that belongs to a layer whose display state is set to “display”, and does not select an object data item that belongs to a layer whose display state is set to “non-display”. For example, the filtering unit 13 does not select an object data item that relates to an object having a predetermined shape or line color.

The filtering unit 13 performs segmentation on the image data (step S32). Specifically, the filtering unit 13 determines whether or not each pixel in the image belongs among room elements. The determination may be made by means of a dictionary created in advance. The room element corresponds to an object of the type designated by the filtering condition associated with the data utilization purpose that matches the input data utilization purpose. In other words, the data utilization purpose of room detection is associated with the filtering condition of extracting an object data item relating to a room element.

The dictionary may be configured to, when image data is input to the dictionary, output, for each pixel included in the image data, data including a label (hereinafter referred to as an “evaluation value”) indicating whether or not the pixel belongs among the room elements. The evaluation value may be discretionarily defined. For example, the evaluation value may be defined as binary; the value “0” indicates that the pixel belongs among the room elements, and the value “1” indicates that the pixel does not belong among the room elements. Alternatively, the evaluation value may represent certainty that the pixel belongs among the room elements. For example, the evaluation value may be defined to take a value in the range from 0 to 1 so as to be larger (closer to 1) when the certainty increases.

The dictionary may be implemented by means of a model, such as a convolutional neural network (CNN), obtained through machine learning. Examples of a CNN for determining whether or not each pixel of an input image belongs to a predetermined category include semantic segmentation. The dictionary may be created by means of semantic segmentation. The method for performing category determination of a pixel is not limited to semantic segmentation, and may be another method. Examples of a CNN for detecting an area of a predetermined object from an input image include a single shot detector (SSD). The dictionary may be created by means of single shot detector. When a single shot detector is used, the dictionary detects an area corresponding to a predetermined object in an image, and assigns a label to each pixel in the image, based on the detection result. For example, an evaluation value close to 1 is assigned to each pixel in an area corresponding to a predetermined object, and an evaluation value close to 0 is assigned to each pixel in other areas. The method for detecting an object from an image is not limited to a single shot detector, and may be another method.

The filtering unit 13 associates each pixel in the image with one of the objects (step S33), and calculates a certainty factor indicating certainty that the object is a room element (step S34). Specifically, the filtering unit 13 may calculate a certainty factor of an object based on the evaluation values of the pixels corresponding to the object. For example, the filtering unit 13 may calculate an average of the evaluation values of the pixels corresponding to the object as a certainty factor. Alternatively, the filtering unit 13 may adopt the maximum value of the evaluation values of the pixels corresponding to the object as a certainty factor. The filtering unit 13 may calculate a certainty factor of an object, using the evaluation values of pixels corresponding to an object connected to or close to the object.

The filtering unit 13 selects an object by performing threshold processing on the calculated certainty factor, and generates a filtering result including an object data item relating to the selected object (step S35). For example, the filtering unit 13 selects an object with a certainty factor exceeding a threshold. The threshold may be a fixed value, or set by a user. In the case where the output unit 14 displays an image based on the filtering result on a screen, a slide bar to change the threshold relating to the certainty factor may be provided on the screen. The filtering result changes as a user operates the slide bar and changes the threshold. For example, when the threshold is decreased, an object data item with a certainty factor exceeding the changed threshold is added to the filtering result. The output unit 14 may change the color of the object newly displayed after the threshold change so that the displays before and after the threshold change can be compared.

In the above-described example, the filtering result includes one or more object data items matching the input data utilization purpose, which are extracted by the filtering unit 13. In other words, the filtering unit 13 generates a filtering result selectively including necessary object data items while removing unnecessary object data items. Alternatively, the filtering unit 13 may generate a filtering result including a plurality of object data items acquired by the data acquisition unit 11 and certainty factors calculated in step S34 in association with each other.

In the above-described example, the filtering unit 13 classifies object data items into two classes, “necessary” and “unnecessary”. Specifically, the filtering unit 13 classifies object data items into two classes “room elements” and “other elements”. Alternatively, the filtering unit 13 may classify object data items into three or more classes. In an example, a plurality of thresholds may be used in threshold processing. For example, the filtering unit 13 determines an object data item relating to an object with a certainty factor below a first threshold as “unnecessary”, an object data item relating to an object with a certainty factor over a second threshold as “necessary”, and an object data item relating to an object with a certainty factor between the first threshold and the second threshold as “to be determined”. The filtering result may include an object data item determined as “necessary” and an object data item determined as “to be determined”. Whether the object date item determined as “to be determined” is necessary or unnecessary can be determined by a user. In another example, the filtering unit 13 may generate a filtering result including an object data item together with a label indicating which of, for example, the three classes “room element”, “hall”, and “other” the object belongs to.

In the above-described example, the filtering unit 13 performs segmentation after imaging object data items. Alternatively, the filtering unit 13 may perform segmentation on the object data items themselves. In the case where the input data is image data and the data acquisition unit 11 obtains object data items by vectorizing the image data, the filtering unit 13 may generate image data from the object data items.

The filtering unit 13 may include a plurality of dictionaries associated with a plurality of data utilization purposes. In this case, the filtering unit 13 selects, from the dictionaries, a dictionary associated with a data utilization purpose that matches the input data utilization purpose, and performs filtering using the selected dictionary.

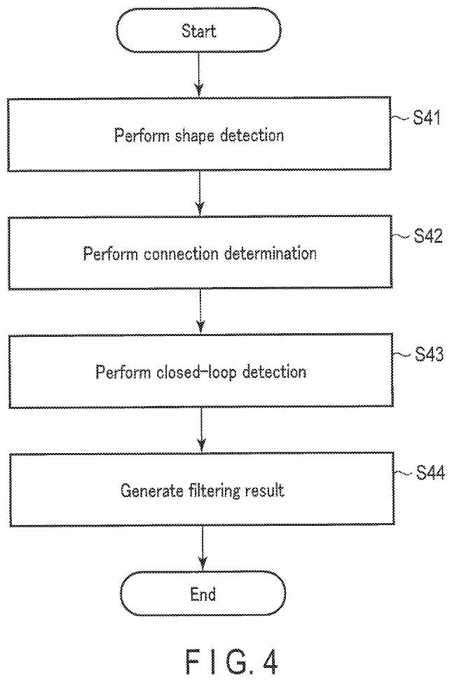

FIG. 4 schematically chows another example of filtering executed by the filtering unit 13. The processing shown in FIG. 4 is an example of processing in which the filtering unit 13 performs filtering using a rule-based dictionary including a rule for detecting an object in a shape designated by each of a plurality of filtering conditions.

The filtering unit 13 performs shape detection on image data (step S41). For example, the filtering unit 13 detects shapes indicating a door and a window in an image. The filtering unit 13 may detect a shape formed by two line segments vertically crossing each other and an arc connecting ends of the line segments as a door shape. By specifying the width of a door in advance, detection accuracy of a door shape can be increased. By specifying the width of a window in advance, the filtering unit 13 can detect a window shape.

The filtering unit 13 performs connection determination (step S42). For example, the filtering unit 13 detects line segments connected to the door and window detected in step S41.

The filtering unit 13 performs closed-loop detection (step S43). For example, the filtering unit 13 detects a closed loop by tracing the door and window detected in step S41 and the line segments detected in step S42 starting from an end point of the door detected in step S41. The filtering unit 13 extracts object data items relating to objects constituting the detected closed loop as object data items that match the input data utilization purpose. The filtering unit 13 repeats the processing from step S41 to S43. An object data item not extracted finally is determined as an unnecessary object data item.

The output unit 14 generates a filtering result including an object data item extracted by the filtering unit 13 (step S44).

In a further example of filtering, the dictionary includes a model configured to detect an object in a shape designated by each filtering condition, which is obtained through learning using a graph network. The filtering unit 13 may determine whether or not each object is an element by means of this model. For example, it is possible to perform node classification by defining a graph including nodes of two different classes corresponding to “necessary elements” and “unnecessary elements” of an object.

As described above, the drawing data processing apparatus 10 acquires drawing data including a plurality of object data items relating to a plurality of objects composing a drawing, acquires attribute information relating to the objects from the object data items, filters the object data items based on the acquired attribute information, a dictionary including a plurality of filtering conditions associated with a plurality of data utilization purposes, and an input data utilization purpose to generate a filtering result, and outputs the filtering result. This configuration enables extraction of object data items necessary for an input data utilization purpose from a plurality of object data items. This partly or completely avoids a user from having to sort out necessary object data items and unnecessary object data items. As a result, user's work efficiency when utilizing drawing data greatly improves.

The processing described above in relation to the drawing data processing apparatus 10 can be implemented by a general-purpose circuit, such as a central processing unit (CPU), executing a program.

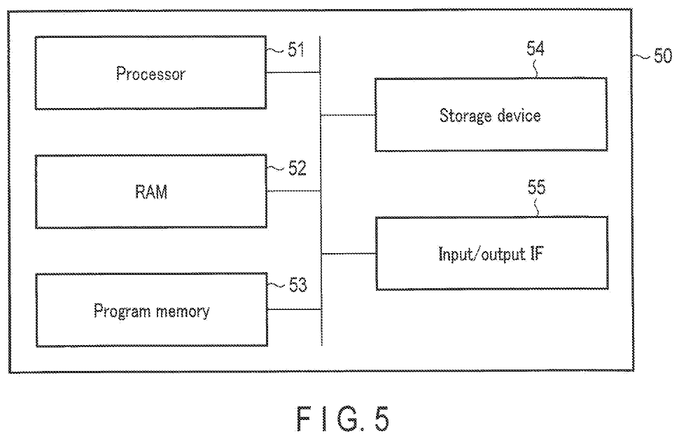

FIG. 5 schematically shows a hardware configuration example of a computer 50 according to one embodiment. As shown in FIG. 5, the computer 50 includes a processor 51, a random access memory (RAM) 52, a program memory 53, a storage device 54, and an input/output interface 55. The processor 51 exchanges signals with the RAM 52, the program memory 53, the storage device 54, and the input/output interface 55 via a bus.

The processor 51 includes, for example, a CPU. The RAM 52 is used by the processor 51 as a working memory. The RAM 52 includes a volatile memory such as a synchronous dynamic random access memory (SDRAM). The program memory 53 stores a program, such as a drawing data processing program, to be executed by the processor 51. The program includes computer-executable instructions. As the program memory 53, for example, a read-only memory (ROM) is used.

The processor 51 loads a program stored in the program memory 53 onto the RAM 52, and interprets and executes the program. When executed by the processor 51, the drawing data processing program causes the processor 51 to execute the processing described above in relation to the drawing data processing apparatus 10. In other words, the processor 51 can function as the data acquisition unit 11, the attribute information acquisition unit 12, the filtering unit 13, and the output unit 14 in accordance with the drawing data processing program.

A program such as a drawing data processing program may be provided to the computer 50 in the state of being stored in a computer-readable storage medium. In this case, for example, the computer 50 may include a drive to read data from the storage medium, and acquire the program from the storage medium. Examples of the storage medium include a magnetic disk, an optical disk (such as a CD-ROM, a CD-R, a DVD-ROM, or a DVD-R), a magneto-optical disk (such as an MO), and a semiconductor memory. A program may be stored in a server on a network, and the computer 50 may download the program from the server.

The storage device 54 stores data. The storage device 54 includes a volatile memory such as a hard disk drive (HDD) or a solid state drive (SSD). The area of the storage device 54 may be partly used as the program memory 53.

The input/output interface 55 is an interface for connecting an external device. The input/output interface 55 may include a port for connecting an input device such as a keyboard and/or an output device such as a display device. The input/output interface 55 may include a communication module for communicating with an external device. The communication module may be a wire communication module or a wireless communication module. The processor 51 receives an input of a data utilization purpose from a user via the input/output interface 55. The processor 51 outputs a filtering result to the output device or external device via the input/output interface 55.

At least part of the processing described above in relation to the drawing data processing apparatus 10 may be performed by a dedicated circuit such as an application specific integrated circuit (ASIC) or a field programmable gate array (FPGA). The processing circuit includes a general-purpose circuit and/or a dedicated circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A drawing data processing apparatus comprising: processing circuitry configured to:
acquire a plurality of object data items relating to a plurality of objects, the objects composing a drawing;
acquire attribute information relating to the objects from the object data items;
filter the object data items based on the acquired attribute information, a dictionary including a plurality of filtering conditions associated with a plurality of data utilization purposes, and an input data utilization purpose to generate a filtering result; and
output the filtering result.

2. The drawing data processing apparatus according to claim 1, wherein the processing circuitry is configured to acquire the object data items by receiving image data and performing raster-to-vector conversion on the image data.

3. The drawing data processing apparatus according to claim 1, wherein the processing circuitry is configured to convert the object data items into image data, and filter the image data to generate the filtering result.

4. The drawing data processing apparatus according to claim 3, wherein the processing circuitry is configured to select at least one of the object data items based on a position, shape, or color of an abject, or a display state of a layer which is specified by the acquired attribute information, and generate the image data from the at least one selected object data item.

5. The drawing data processing apparatus according to claim 3, wherein the dictionary configured to, when the image data is input, output, for each pixel included in the image data, data including a label indicating whether or not the pixel belongs among objects of a type designated by a filter ng condition associated with the input data utilization purpose.

6. The drawing data processing apparatus according to claim 5, wherein the processing circuitry is configured to calculate, for each of the objects, a certainty factor indicating certainty that the object is an object of the type designated by the filtering condition associated with the input data utilization purpose, extract an object data item that matches the input data utilization purpose from the object data items based on the calculated certainty factor, and generate the filtering result including the extracted object data item.

7. The drawing data processing apparatus according to claim 5, wherein the processing circuitry is configured to calculate, for each of the objects, a certainty factor indicating certainty that the object is an object of the type designated by the filtering condition associated with the input data utilization purpose, and generate the filtering result including the calculated certainty factor.

8. The drawing data processing apparatus according to claim 1, wherein the dictionary includes a rule for detecting an object in a shape designated by each of the filtering conditions.

9. The drawing data processing apparatus according to claim 1, wherein the dictionary includes a model configured to detect an object in a shape designated by each of the filtering conditions.

10. The drawing data processing apparatus according to claim 1, wherein the processing circuitry is configured to classify the object data items into three or more classes including “necessary” and “unnecessary”.

11. The drawing data processing apparatus according to claim 1, wherein
the dictionary includes a plurality of dictionaries associated with the data utilization purposes, and
the processing circuitry is configured to select, from the dictionaries, a dictionary associated with the input data utilization purpose, and filters the object data items using the selected dictionary.

12. A drawing data processing method comprising:
acquiring a plurality of object data items relating to a plurality of objects, the objects composing a drawing;
acquiring attribute information relating to the objects from the object data items;
filtering the object data items based on the acquired attribute information, a dictionary including a plurality of filtering conditions associated with a plurality of data utilization purposes, and an input data utilization purpose to generate a filtering result; and
outputting the filtering result.

13. A non-transitory computer readable medium including computer executable instructions, wherein the instructions, when executed by a processor, cause the processor to perform a method comprising:
acquiring a plurality of object data items relating to a plurality of objects, the objects composing a drawing;
acquiring attribute information relating to the objects from the object data items;
filtering the object data items based on the acquired attribute information, a dictionary including a plurality of filtering conditions associated with a plurality of data utilization purposes, and an input data utilization purpose to generate a filtering result; and
outputting the filtering result.
